(19) United States
(12) Patent Application Publication
(10) Pub. No.: US 2005/0135457 A1
(43) Pub. Date: Jun. 23, 2005

(54) Ultra wide bandwidth transmitter with tone grouping and spreading

(76) Inventors: Andreas F. Molisch, Arlington, MA (US); Yves-Paul Nakache, Cambridge, MA (US); Philip Orlik, Cambridge, MA (US); Iyappan Ramachandran, Seattle, WA (US)

Correspondence Address: Mitsubishi Electric Research Laboratories, Inc.;Patent Department, 201 Broadway, Cambridge, MA, 02139, US

(21) Appl. No.: 10/741,564

(22) Filed: Dec. 19, 2003

(51) Int. Cl. H04B 1/69

(52) U.S. Cl. 375/130

(57) ABSTRACT

A method and system communicates ultra wide bandwidth signals using orthogonal frequency division multiplexing modulation. QPSK input symbols are frequency interleaved. The frequency interleaved symbols are spread over a plurality of tones, and the tones are modulated for transmission over an ultra wide bandwidth channel. When the tones are received, the received tones can be de-spreaded to recover the input symbols.

### FIELD OF THE INVENTION

The present invention relates generally to radio communication systems, and more particularly to ultra wide bandwidth communications systems that use orthogonal frequency division multiplexing.

### BACKGROUND OF THE INVENTION

With the release of the “First Report and Order,” Feb. 14, 2002, by the Federal Communications Commission (FCC), interest in ultra wide bandwidth (UWB) communication systems has increased. The IEEE 802.15 standards organization, which is responsible for personal area networks (PANs), has established a task group, TG3a, to standardize a high-data-rate physical layer based on UWB.

UWB communication systems spread information over a wide bandwidth of at least 500 MHz. Due to this spreading operation, the power spectral density, and thus the interference to existing narrow bandwidth receivers, is small. For that reason, the Report and Order allows the restricted use of unlicensed UWB transmitters.

A possible application for UWB communication is the transmission of very high data rates over short distances in PANs. Recognizing these possibilities, the IEEE has established a standardization body, IEEE 802.15.3a. to define a physical-layer standard for UWB communications with data rates of 110 Mbit/s, 200 Mbit/s, and 480 Mbit/s.

In the past, UWB systems consider mostly impulse radio. More recently, a combination of orthogonal frequency division multiplexing (OFDM) with time-frequency interleaving has been considered. There, the available spectrum is partitioned into several subbands, each with an approximate bandwidth of 500 MHz, which is the minimum bandwidth allowed by the FCC to constitute a UWB signal.

During one time instant, information is transmitted over a single such subband, and the subband changes over time. Within each subband, the OFDM modulation format is used. Essentially, OFDM divides the available spectrum into multiple ‘tones’, where each tone is generated according to a frequency-flat transfer function. This greatly simplifies equalization of a received signal, because the received signal can be equalized on a tone-by-tone basis.

In a typical prior art transceiver, e.g., a transceiver operating in the 480 Mbit/s mode, input data from a source, after scrambling, are encoded using compatible punctured convolutional codes at a rate of ¾. The resulting bits are then interleaved, so that information belonging to different bits is transmitted in different subbands of 500 MHz. The bits are then assigned to complex symbols using a constellation mapping, e.g., two bits result from one quadrature phase shift keying (QPSK) transmission symbol. The resulting bit stream is then serial-to-parallel converted.

Blocks of 100 tones are formed, and guard-tones and pilot-tones are added, resulting in a block of 128 tones. This block is input to a fast inverse Fourier transformation (IFFT). After parallel-to-serial conversion, a cyclic prefix, zero-preamble, or zero-postamble is added.

The resulting modulated signal is then upconverted by mixing with a time-varying local oscillator signal. A different oscillator is used for each transmitted OFDM block. The frequencies of the different oscillators are offset by multiples of approximately 500 MHz. The different local oscillators can all be derived from a master oscillator.

This signal is sent over a possibly frequency-selective wireless channel that leads to linear distortions, as well as added noise.

At the receiver, the sequence of operations of the transmitter is reversed. After conventional front-end operations, including low noise amplification, I/Q channel separation, down conversion to baseband and low-pass filtering, the I/Q signal components are digitized. After A/D conversion, the digital portion of the receiver operates on samples.

First, prefix/postfix samples are removed from each OFDM symbol and the remaining samples are passed to a fast Fourier transform (FFT) block of size 128. The output of the FFT block contains pilot and guard tones. The symbols in the pilot tones are used for channel estimation as well as synchronization tracking. Guard tones are discarded.

After processing pilot and guard tones, the remaining 100 tones are de-interleaved and passed to a Viterbi decoder and descrambler to obtain the original data.

As major disadvantage, the prior art OFDM does not exploit an inherent frequency diversity of the channel. If a symbol is transmitted on a tone that is subject to fading, then that symbol has a low SNR at the receiver. If the signal is strongly coded, then the probability that the symbol results in a detected error is low. This can also be interpreted differently. Any error correction code leads to a spreading of the original data over a number of tones. In other words, several of the transmit symbols on different tones contain information about a single data bit. Thus, coded OFDM transmission is robust with respect to fading. However, performance degrades for a high code rate with low redundancy.

It is desired to alleviate these problems.

### SUMMARY OF THE INVENTION

The invention uses frequency interleaving, grouping of tones, and spreading the tones over different frequencies to increase frequency diversity in ultra wide bandwidth (UWB) communication systems that use orthogonal frequency division multiplexing modulation combined with time-frequency interleaving.

By spreading the information bits over all available tones, frequency diversity is greatly increased. The invention allows one to trade-off noise enhancement that is inherent in the frequency spreading, with the amount of desired gain in frequency diversity.

Specifically, a method and system communicates ultra wide bandwidth signals using orthogonal frequency division multiplexing modulation.

QPSK input symbols are frequency interleaved. The frequency interleaved symbols are spread over a plurality of tones, and the tones are modulated for transmission over an ultra wide bandwidth channel.

When the tones are received, the received tones can be de-spreaded to recover the input symbols.

### BRIEF DESCRIPTION OF THE DRAWINGS

FIG. 1 is a block diagram of a UWB transmitter according to the invention;

FIG. 2 is a block diagram of a UWB receiver according to the invention;

FIG. 3 is a block diagram of spreading groups of tones in a receiver according to the invention;

FIG. 4 is a block diagram of de-spreading groups of tones in a transmitter according to the invention; and

FIG. 5 is a block diagram of Walsh-Hadamard orderings used by the invention.

### DETAILED DESCRIPTION OF A PREFERRED EMBODIMENT OF THE INVENTION

An ultra wide bandwidth (UWB) transceiver according to the invention, which uses orthogonal frequency division multiplexing modulation, spreads information over groups of tones. This code division multiple access technique has never been used in UWB transceivers with time-frequency interleaving.

To spread the information, in the form of quadrature phase shift keying (QPSK) symbols over N tones, two set of N bi-orthogonal vectors aᵢ, bⱼ are used. This means that each symbol is transmitted over N tones. In the prior art, each symbol is transmitted by only one tone. The vectors are arranged in matrix forms.

Bi-orthogonal means that an inner product aᵢ*bⱼ is equal to δᵢⱼ, where δ is the Kronecker delta value. It should be noted that all of the vectors do not need to be orthogonal to each other. However, for many bi-orthogonal sequences, particularly the well known Walsh-Hadamard vectors, each vector aᵢ is equal to a vector bi. Therefore, the spreading operation may be implemented as a matrix-vector product. That is, the vector of N symbols is multiplied by an N×N Walsh-Hadamard Matrix.

The Walsh-Hadamard transform of Hadamard order (WHTₕ) is defined as

$$\{ \begin{matrix}\overline{X} = H \overline{x} \\ \overline{x} = H \overline{X}\end{matrix} .$$

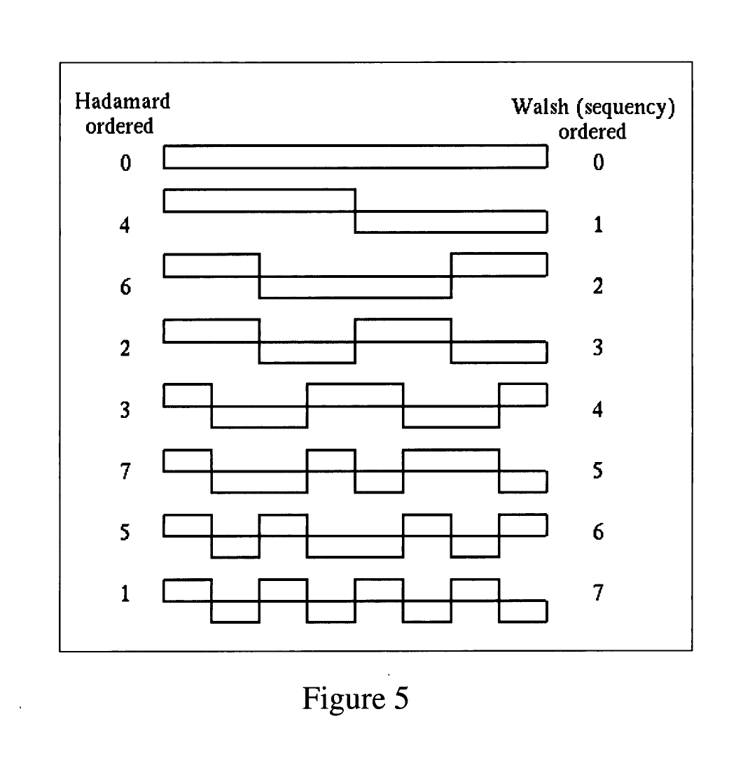

These are the forward and inverse WHTₕ transform pair, where
\overline{x}=[x(0),x(1), . . . ,x(N−1)^{T} and \overline{X}=[X(0),X(1), . . . ,X(N−1)^{T} are the signal and spectrum vectors, respectively. An example ordering for a 4×4 Walsh-Hadamard matrix is shown in FIG. 5.

Bi-orthogonality is not necessary for the invention to work. Any linearly independent set of transmit vectors can be used for the mapping. However, decoding in the receiver is simpler when the bi-orthogonal vectors correspond to the transmit vectors.

Transmitter Structure and Operation

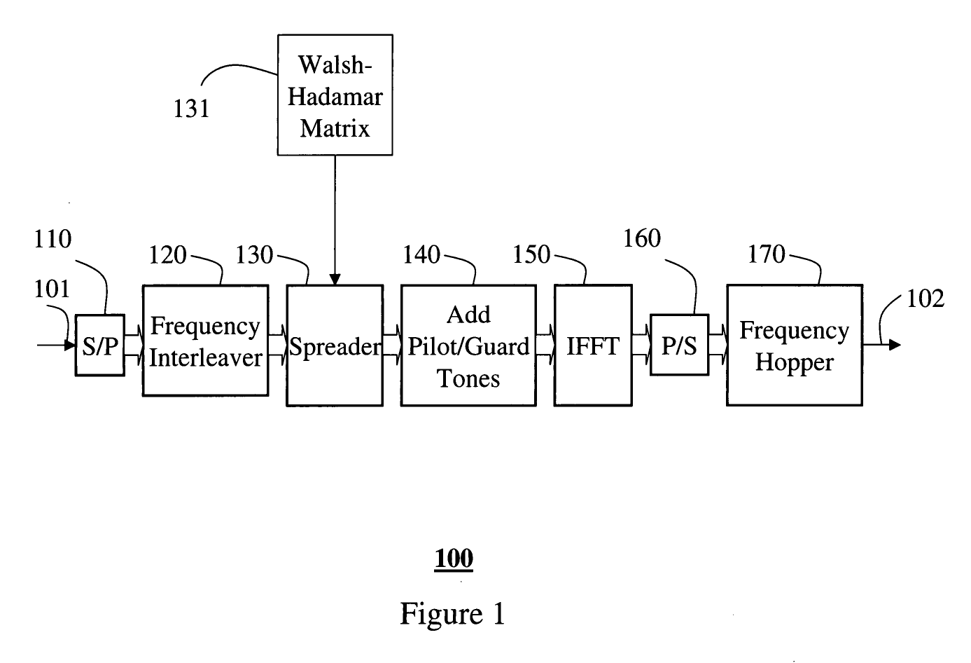

FIG. 1 shows a multicarrier-OFDM transmitter according to the invention. In our transmitter, the OFDM symbols are spread over a multiple tones by multiplying each symbol with the Walsh-Hadamard sequences arranged in a matrix.

The transmitter 100 takes as input QPPK symbols 101. The symbols are serial-to-parallel converted 110. The symbols are frequency interleaved 120. A matrix 131 is constructed. Each row in the matrix correspond to an individual Walsh-Hadamard sequence.

The frequency interleaved QPSK symbols are grouped into blocks of size N. i.e., the blocks are vectors of length N. The interleaved symbols in each block are spread 130 over N tones according to the N×N Walsh-Hadamard matrix 131 by using a vector-matrix multiply operation.

Pilot and guard tones are added 140, and all tones are subjected to an inverse fast Fourier transform (IFFT) 150. All of the resulting tones are parallel-to-serial converted 160, and frequency hopping is applied 170, before the modulated tones are transmitted over a UWB channel 102.

Receiver Structure and Operation

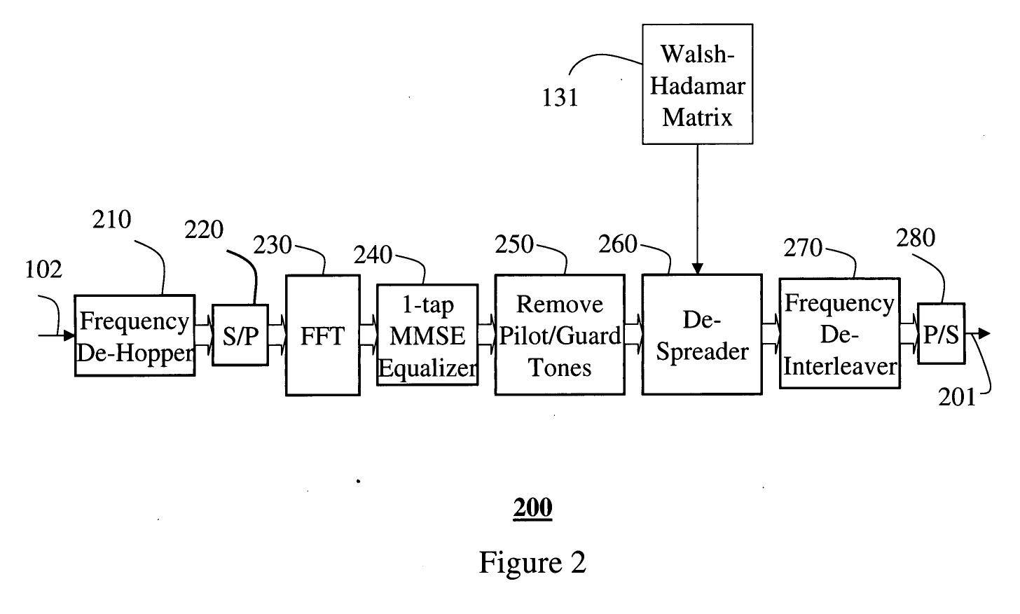

In the receiver as shown in FIG. 2, the operations proceed essentially in an inverse order. The transmitted signal is received via the channel 102, and is frequency de-hopped 210 and serial-to-parallel converted 220. The serial samples are passed to a fast Fourier transform (FFT) 230. The output of the FFT block 230 are equalized 240. This output contains pilot and guard tones. The symbols modulated on the pilot tones are used for channel estimation as well as synchronization tracking. The pilot and guard tones are removed 250.

Next, after the equalization of the OFDM block and tone removal, the received vector, i.e., tones, are de-spreaded 260 by multiplying by the vectors bⱼ of the Walsh-Hadamard matrix 131. Finally, the de-spreaded symbols are frequency de-interleaved 270, and parallel-to-serial converted 270 to recover the original QSPK symbols 201.

Because each QPSK symbols is transmitted using multiple tones, a frequency diversity of degree up to N, when all of the tones are independently fading, has been achieved.

Note that the method according to the invention can increase the amount of noise. That is, the equalization 240, e.g., MMSE or zero-forcing, increases the amount of noise in the weak tones, and the de-spreading 260 operation distributes this noise among all available tones.

Grouping of Tones

Prior art spreading codes generally use a power of two for N, that is, one symbol is spread over two tones. In order to improve flexibility, the invention prefers to group tones according to a power of 2^{k}, where k is an integer greater than one. The sum of all of the tones in all groups results in a desired number of tones, e.g., 100.

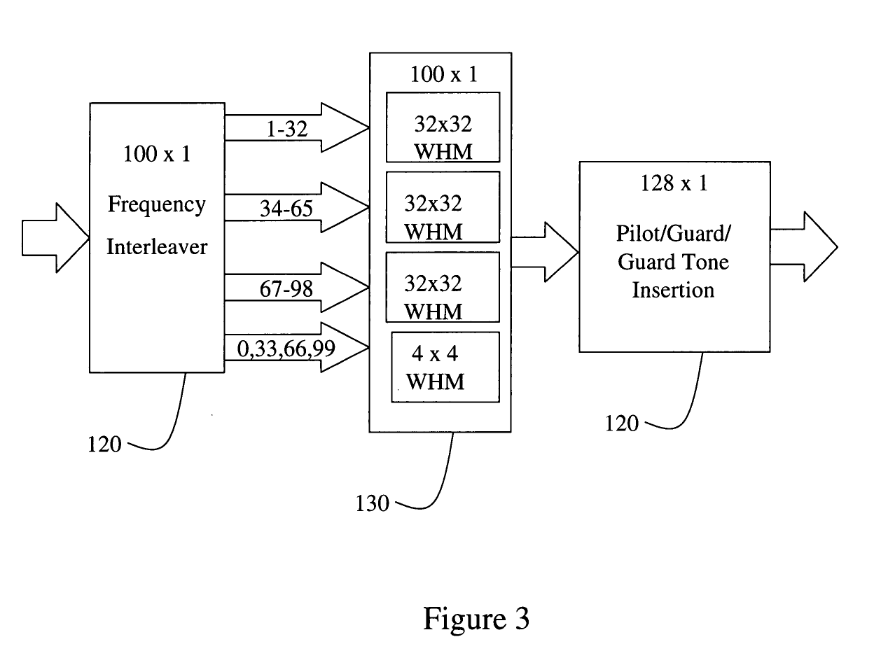

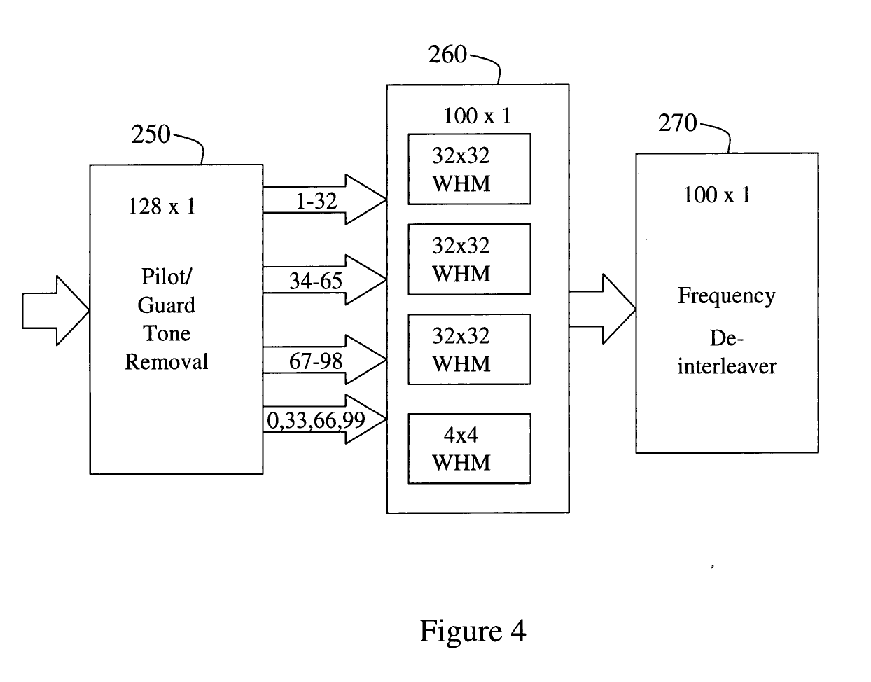

As shown in FIGS. 3 and 4 for the transmitter 100 and receiver 200, respectively, the 100 tones can be grouped into three groups of thirty-two (2⁵) tones and one group of four tones (2²). The four tones are on either sides of the groups of thirty-two tones, e.g., tones 0, 33, 66, and 99. Then, each of the groups is spread 130 separately.

The flexibility offered by the grouping of tones is especially important for the receiver described herein. Some of the tones are pilot tones that are used to track the carrier phase. These tones should not be spread. Furthermore, the guard tones, which have a lower SNIR, should also not be spread. Thus, the grouping according to the invention leads to an increased flexibility in the number of treated tones when certain types of spreading sequences, such as the Walsh-Hadamard sequences, are used.

The invention can use many different possible groupings of tones. For example, M contiguous tones can be assigned as one group. Alternatively, interleaved tones can be grouped: tones 1, 4, 7, 10, . . . can be assigned to one group, while tones 2, 5, 8, 11, . . . are assigned to another group, and so forth. Also, any intermediate grouping or mixtures of grouping can be used.

The selection of a particular grouping depends on a configuration of the channel. Spreading increases the frequency diversity in the system, the average SNR is decreased due to noise enhancements. Depending on the channel constellation, as well as the desired bit error rate, a particular grouping can lead to an optimum tradeoff between the diversity gain and SNR.

It should be understood, that the groupings of tones can be adaptive based on an instantaneous or an average channel condition.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for communicating ultra wide bandwidth signals using orthogonal frequency division multiplexing modulation, comprising:
frequency interleaving a symbol to be transmitted over an ultra wide bandwidth channel;
spreading the frequency interleaved symbol over a plurality of tones; and
modulating the plurality of tones for transmission over an ultra wide bandwidth channel.

2. The method of claim 1, in which the modulating step uses orthogonal frequency division multiplexing.

3. The method of claim 1, in which the symbol is spread by multiplying the symbol by a plurality of bi-orthogonal vectors, there being one vector for each tone.

4. The method of claim 3, in which the bi-orthogonal vectors are Walsh-Hadamard vectors.

5. The method of claim 3, in which the bi-orthogonal vectors are arranged in a matrix so that each row of the matrix is one of the bi-orthogonal vectors.

6. The method of claim 3, in which the multiplying step is a vector-matrix multiply operation.

7. The method of claim 1, further comprising:
adding pilot and guard tones to the plurality of tones before transmitting.

8. The method of claim 1, in which the symbol is a QSPK symbol.

9. The method of claim 1, further comprising:
receiving the plurality of tones;
de-spreading the plurality transmitted tones to recover the symbol.

10. The method of claim 9, in which the de-spreading step multiplies the plurality of tones the plurality of bi-orthogonal vectors, there being one vector for each tone.

11. The method of claim 1, wherein the number of tones is 2^{k}, where k is an integer larger tall greater than or equal to one.

12. The method of claim 1, in which the plurality of tones include a plurality of groups of tones, and in which each group of tones is spread separately.

13. The method of claim 12, in where there are 100 tones consisting of three groups of 32 tones, and one group of four tones.

14. The method of claim 12, in which the grouping is adaptive to an instantaneous channel condition.

15. The method of claim 12, in which the grouping is adaptive to an average channel condition.

16. The method of claim 5, in which the matrix includes a set of N vectors aᵢ, bⱼ.

17. A transmitter for communicating ultra wide bandwidth signals using orthogonal frequency division multiplexing modulation, comprising:
a frequency interleaver configured to receive a symbol to be transmitted over an ultra wide bandwidth channel;
a spreader, connected to an output of the frequency interleaver, configured to spread a frequency interleaved symbol over a plurality of tones; and
a modulator, connected to an output of the spreader, configured to modulate the plurality of tones for transmission over an ultra wide bandwidth channel.
